(19) United States
(12) Patent Application Publication
(10) Pub. No.: US 2022/0089902 A1
(43) Pub. Date: Mar. 24, 2022

(54) PIGMENTED COATING COMPOSITIONS HAVING LOW SOLVENT CONTENT

(71) Applicant: Covestro LLC, Pittsburgh, PA (US)

(72) Inventors: Daniel P. Wang, Pittsburgh, PA (US); Kurt E. Best, Wexford, PA (US)

(21) Appl. No.: 17/030,913

(22) Filed: Sep. 24, 2020

(51) Int. Cl. C09D 175/12; C09D 175/02; C08G 18/73; C08G 18/38; C08G 18/32; C08G 18/10; C08K 3/013; C08K 3/22; C08K 3/34; C08K 5/57

(52) U.S. Cl. CPC C09D 175/12; C09D 175/02; C08G 18/73; C08G 18/3821; C08G 18/3228; C08K 2003/2241; C08K 3/013; C08K 3/22; C08K 3/34; C08K 5/57; C08G 18/10

(57) ABSTRACT

A coating composition can include an aliphatic polyisocyanate and a polyaspartate combined at an equivalent ratio of from 0.9 to 1.8, the aliphatic polyisocyanate having an NCO % of from 6 wt % to 25 wt % based on ISO 11909:2007. The coating composition can also include a pigment at a pigment to binder ratio of from 0.05 to 1.3 and a drying agent in an amount of from 0.5 wt % to 5 wt % based on a total weight of the coating composition. The coating composition can have a total solvent content of less than or equal to 250 g/L.

### BACKGROUND

Compositions based on isocyanate chemistry find utility as components in coatings, such as, for example, paints, primers, and the like. Isocyanate-based coating compositions may include, for example, polyurethane or polyurea coatings formed from resins comprising components, such as, for example, diisocyanates, polyisocyanates, isocyanate reaction products, the like, or a combination thereof. These resins may cure by various mechanisms so that covalent bonds form between the resin components, thereby producing a cross-linked polymer network.

Environmental regulations are imposing increasingly lower volatile organic compound (VOC) limits on various coating compositions, such as architectural and industrial maintenance coatings, for example. In some jurisdictions, government regulations permit the use of “exempt solvents” that do not apply toward the VOC limit in coatings. Examples of “exempt solvents” include HFE-134, HFE-236ca12, HFE-338pcc13, H-Galden 1040X, HFE-347pcf2, HFO-1336mzz-Z, trans-1-chloro-3,3,3-trifluoroprop-1-ene, 2,3,3,3-tetrafluorpropene, 2-amino-2-methyl-1-propanol, and t-butyl acetate. In jurisdictions where the use of “exempt solvents” is permitted, they can help mitigate some of the challenges associated with coating compositions required to have increasingly lower solvent content. Such challenges can include increased viscosity, decreased pot life, etc. However, the use of “exempt solvents” is only a temporary solution and novel approaches are needed to achieve coating compositions having low VOCs without having to rely on “exempt solvents.”

### DETAILED DESCRIPTION

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a polymer” or “the polymer” can include a plurality of such polymers.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 milligrams to about 80 milligrams” should also be understood to provide support for the range of “50 milligrams to 80 milligrams.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well. Unless otherwise specified, all numerical parameters are to be understood as being prefaced and modified in all instances by the term “about,” in which the numerical parameters possess the inherent variability characteristic of the underlying measurement techniques used to determine the numerical value of the parameter.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 to 5” should be interpreted to include not only the explicitly recited values of 1 to 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

As described above, various coating compositions are subject to environmental regulations imposing increasingly stricter limits on volatile organic compounds (VOCs). While some jurisdictions allow for exempt solvents to be excluded from VOC limit requirements, this is only a temporary solution. A need remains to provide suitable coating compositions with low total solvent content. However, reducing the amount of solvents in a coating composition can affect the coating composition in a number of ways. As non-limiting examples, reducing the amount of solvents in the coating composition can increase the starting viscosity of the coating composition and the rate of viscosity build, which can both negatively impact the pot life of the coating composition, for example. Additionally, the inclusion of various additives, such as pigments, thixotropic agents, the like, or a combination thereof, in the low-VOC coating composition can further increase the starting viscosity of the coating composition, which can further decrease the pot life of the coating composition, in some examples.

The present disclosure describes a pigmented coating composition with low total solvent content that can have a reasonable pot life and a reasonable hard-dry time. For example, the pigmented coating composition can include an aliphatic polyisocyanate combined with a polyaspartate at an equivalent ratio of from 0.9 to 1.8 (NCO/NH). The aliphatic polyisocyanate can typically have an NCO % of from 6 wt % to 25 wt % based on ISO 11909:2007. The coating composition can also include a pigment at a pigment to binder ratio of from 0.1 to 1.3 and a drying agent in an amount of from 0.5 wt % to 5 wt % based on a total weight of the coating composition. Additionally, the coating composition can generally be formulated to have a total solvent content of less than or equal to 250 g/L.

In further detail, the NCO content of the aliphatic polyisocyanate can generally be selected to provide both a suitable pot life for the coating composition and also other suitable properties for the final coating. For example, generally the greater the NCO % of the aliphatic polyisocyanate the greater the average viscosity build rate of the resulting coating composition will be. As coating compositions with low total solvent have a relatively high initial viscosity, aliphatic polyisocyanates with high NCO % can present challenges with respect to achieving a reasonable pot life. Additionally, generally the lower the NCO % the lower the hardness of the final coating will be. Thus, in some cases, the aliphatic polyisocyanate can have an NCO % of from 6 wt % to 25 wt % based on ISO 11909:2007 to provide a coating composition with a reasonable average viscosity build rate and to provide a final coating with a suitable hardness. In other examples, the aliphatic polyisocyanate can have an NCO % of from 6 wt %, to 10 wt %, from 8 wt % to 12 wt %, from 10 wt % to 14 wt %, from 12 wt % to 17 wt %, from 15 wt % to 20 wt %, from 18 wt % to 22 wt %, or from 20 wt % to 25 wt % based on ISO 11909:2007.

Additionally, the aliphatic polyisocyanate can have a variety of number average NCO functionalities. Number average NCO functionality (Fn) can be determined via gel permeation chromatography as follows: Fn=number average molecular weight (Mn)/equivalent weight. Typically, polystyrene retention time standards can be used. With this in mind, in some examples, the aliphatic polyisocyanate can have a number average NCO functionality of from 2.3 to 3.7 based on gel permeation chromatography. In additional examples, the aliphatic polyisocyanate can have a number average NCO functionality of from 2.3 to 2.7, from 2.5 to 2.9, from 2.7 to 3.1, from 3.1 to 3.5, or from 3.3 to 3.7 based on gel permeation chromatography.

Further, the aliphatic polyisocyanate can generally have a weight average molecular weight of from 400 grams per mol (g/mol) to 3500 g/mol based on gel permeation chromatography using polystyrene standards. In some examples, the aliphatic polyisocyanate can have a weight average molecular weight of from 600 g/mol to 1200 g/mol, from 1200 g/mol to 2400 g/mol, or from 2400 g/mol to 3400 g/mol based on gel permeation chromatography using polystyrene standards. In some additional examples, the aliphatic polyisocyanate can have a weight average molecular weight of from 400 g/mol to 1000 g/mol, from 750 g/mol to 1250 g/mol, from 1000 g/mol to 1500 g/mol, from 1250 g/mol to 1750 g/mol, from 1500 g/mol to 2000 g/mol, from 1750 g/mol to 2250 g/mol, from 2000 g/mol to 2500 g/mol, from 2250 g/mol to 2750 g/mol, from 2500 g/mol to 3000 g/mol, from 2750 g/mol to 3250 g/mol, or from 3000 g/mol to 3500 g/mol based on gel permeation chromatography using polystyrene standards.

A variety of aliphatic polyisocyanates, or a combination of aliphatic polyisocyanates, can be included in the coating composition. As used herein, the term “polyisocyanate” refers to compounds comprising at least two un-reacted isocyanate groups. The term “diisocyanate” refers to compounds having two un-reacted isocyanate groups. Thus, “diisocyanate” is a subset of “polyisocyanate.” Polyisocyanates can include biurets, isocyanurates, uretdiones, isocyanate-functional urethanes, isocyanate-functional ureas, isocyanate-functional iminooxadiazine diones, isocyanate-functional oxadiazine diones, isocyanate-functional carbodiimides, isocyanate-functional acyl ureas, isocyanate-functional allophanates, the like, or combinations thereof.

As non-limiting examples, isocyanurates may be prepared by the cyclic trimerization of polyisocyanates. Trimerization may be performed, for example, by reacting three (3) equivalents of a polyisocyanate to produce 1 equivalent of isocyanurate ring. The three (3) equivalents of polyisocyanate may comprise three (3) equivalents of the same polyisocyanate compound, or various mixtures of two (2) or three (3) different polyisocyanate compounds. Compounds, such as, for example, phosphines, Mannich bases and tertiary amines, such as, for example, 1,4-diaza-bicyclo[2.2.2]octane, dialkyl piperazines, or the like, may be used as trimerization catalysts. Iminooxadiazines may be prepared by the asymmetric cyclic trimerization of polyisocyanates. Uretdiones may be prepared by the dimerization of a polyisocyanate. Allophanates may be prepared by the reaction of a polyisocyanate with a urethane. Biurets may be prepared via the addition of a small amount of water to two equivalents of polyisocyanate and reacting at slightly elevated temperature in the presence of a biuret catalyst. Biurets may also be prepared by the reaction of a polyisocyanate with a urea.

In some specific examples, the aliphatic polyisocyanate can include a linear aliphatic polyisocyanate. As used herein, “linear aliphatic polyisocyanate” refers to a polyisocyanate that is prepared from or based on a linear isocyanate monomer, such as 1,4-tetramethylene diisocyanate, 1,5-pentamethylene diisocyanate, or 1,6-hexamethylene diisocyanate, etc. Thus, for example, while the structure of a trimer of 1,6-hexamethylene diisocyanate may not be entirely linear, it is based on the linear monomeric 1,6-hexamethylene diisocyanate and is therefore considered a “linear aliphatic polyisocyanate” for the purposes of this disclosure. Non-limiting examples of linear aliphatic polyisocyanates can include 1,4-tetramethylene diisocyanate, 1,5-pentamethylene diisocyanate (PDI), 1,6-hexamethylene diisocyanate (HDI), a trimer of HDI, a trimer of PDI, a biuret of HDI, a biuret of PDI, an allophanate of HDI, an allophanate of PDI, an allophanate of a trimer of HDI, an allophanate of a trimer of PDI, 2,2,4-trimethyl-hexamethylene diisocyanate, 2,4,4-trimethyl-hexamethylene diisocyanate, dodecamethylene diisocyanate, 2-methyl-1,5-diisocyanatopentane, the like, or a combination thereof.

In some specific examples, the linear aliphatic polyisocyanate can be or include an HDI polyisocyanate. In some additional specific examples, the linear aliphatic polyisocyanate can be or include a PDI polyisocyanate. In some specific examples, the linear aliphatic polyisocyanate can be or include a biuret, such as a biuret of HDI, a biuret of PDI, or a combination thereof. In some additional specific examples, the linear aliphatic polyisocyanate can be or include a trimer, such as a trimer of HDI, a trimer of PDI, or a combination thereof. In still further specific examples, the linear aliphatic polyisocyanate can be or include an allophanate, such as an allophanate of HDI, an allophanate of PDI, an allophanate of a trimer of HDI, an allophanate of a trimer of PDI, or a combination thereof.

Further, in some examples, the aliphatic polyisocyanate can include a cycloaliphatic polyisocyanate. In some examples, the aliphatic polyisocyanate does not include a cycloaliphatic polyisocyanate. Where included, a variety of cycloaliphatic polyisocyanates can be included in the aliphatic polyisocyanate. Non-limiting examples can include 1-isocyanato-3,3,5-trimethyl-5-isocyanato-methylcyclohexane (IPDI), 2,4-diisocyanato-dicyclohexyl-methane, 4,4′ diisocyanato-dicyclohexyl-methane, 1-isocyanato-1-methyl-3(4)-isocyanatomethyl-cyclohexane (IMCI), 1,4-cyclohexane diisocyanate (CHDI), the like, or a combination thereof. In some specific examples, the cycloaliphatic polyisocyanate can include a secondary isocyanate group. By “secondary isocyanate group,” it is meant an isocyanate group bonded to a secondary carbon atom. In some examples, a secondary isocyanate group can increase the pot life for a corresponding coating composition due to lower reactivity as compared to a primary isocyanate group.

In some specific examples, the cycloaliphatic polyisocyanate can be or include a biuret, a trimer, an allophanate, the like, or a combination thereof. For example, in some cases, the cycloaliphatic polyisocyanate can be or include a trimer, such as a trimer of IPDI, a trimer of 2,4-diisocyanato-dicyclohexyl-methane, a trimer of 4,4′ diisocyanato-dicyclohexyl-methane, a trimer of IMCI, a trimer of CHDI, or a combination thereof. In other examples, the cycloaliphatic polyisocyanate can be or include a biuret, such as a biuret of IPDI, a biuret of 2,4-diisocyanato-dicyclohexyl-methane, a biuret of 4,4′ diisocyanato-dicyclohexyl-methane, a biuret of IMCI, a biuret of CHDI, or a combination thereof. In still additional examples, the cycloaliphatic polyisocyanate can be or include an allophanate, such as an allophanate of IPDI, an allophanate of 2,4-diisocyanato-dicyclohexyl-methane, an allophanate of 4,4′ diisocyanato-dicyclohexyl-methane, an allophanate of IMCI, an allophanate of CHDI, or a combination thereof.

Additionally, in some examples, the aliphatic polyisocyanate can include an isocyanate-terminated reaction product of an aliphatic polyisocyanate and an isocyanate-reactive material. Where this is the case, the aliphatic polyisocyanate can be or include a linear aliphatic polyisocyanate, a cycloaliphatic polyisocyanate, or a combination thereof. The linear aliphatic polyisocyanate can include one or more of the linear aliphatic polyisocyanates described elsewhere herein. Similarly, the cycloaliphatic polyisocyanate can include one or more of the cycloaliphatic polyisocyanates described elsewhere herein.

A variety of isocyanate-reactive materials can be combined with the aliphatic polyisocyanate and allowed to react to produce the isocyanate-terminated reaction product. For example, the isocyanate-reactive material can generally include a polyol or polyamine that is based on a polyether, a polyester, a polycarbonate, a polycarbonate ester, a polycaprolactone, a polybutadiene, the like, or a combination thereof. In some specific examples, the isocyanate-reactive material can include a polyether polyol. In some additional specific examples, the isocyanate-reactive material can include a polyester polyol. Additionally, the isocyanate-reactive material can generally have a number average molecular weight of from 300 g/mol to 6000 g/mol.

Examples of polyether polyols can be formed from the oxyalkylation of various polyols, for example, glycols such as ethylene glycol, 1,2-1,3- or 1,4-butanediol, 1,6-hexanediol, and the like, or higher polyols, such as trimethylol propane, pentaerythritol and the like. One commonly utilized oxyalkylation method is by reacting a polyol with an alkylene oxide, for example, ethylene oxide or propylene oxide in the presence of a basic catalyst or a coordination catalyst such as a double-metal cyanide (DMC).

Examples of suitable polyester polyols can be prepared by the polyesterification of organic polycarboxylic acids, anhydrides thereof, or esters thereof with organic polyols. Preferably, the polycarboxylic acids and polyols are aliphatic or aromatic dibasic acids and diols.

The diols which may be employed in making the polyester include alkylene glycols, such as ethylene glycol, 1,2-1,3- or 1,4-butanediol, neopentyl glycol and other glycols such as cyclohexane dimethanol, caprolactone diol (for example, the reaction product of caprolactone and ethylene glycol), polyether glycols, for example, poly(oxytetramethylene) glycol and the like. However, other diols of various types and, as indicated, polyols of higher functionality may also be utilized in various embodiments of the invention. Such higher polyols can include, for example, trimethylol propane, trimethylol ethane, pentaerythritol, and the like, as well as higher molecular weight polyols such as those produced by oxyalkylating low molecular weight polyols.

The acid component of the polyester can include primarily monomeric carboxylic acids, or anhydrides thereof, or esters thereof having 2 to 18 carbon atoms per molecule. Among the acids that are useful are phthalic acid, isophthalic acid, terephthalic acid, tetrahydrophthalic acid, hexahydrophthalic acid, adipic acid, succinic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid.

In addition to polyester polyols formed from polybasic acids and polyols, polycaprolactone-type polyesters can also be employed. These products are formed from the reaction of a cyclic lactone such as ε-caprolactone with a polyol containing primary hydroxyls such as those mentioned above. Such products are described in U.S. Pat. No. 3,169,949, which is incorporated herein by reference.

Suitable hydroxy-functional polycarbonate polyols may be those prepared by reacting monomeric diols (such as 1,4-butanediol, 1,6-hexanediol, di-, tri- or tetraethylene glycol, di-, tri- or tetrapropylene glycol, 3-methyl-1,5-pentanediol, 4,4′-dimethylolcyclohexane and mixtures thereof) with diaryl carbonates (such as diphenyl carbonate, dialkyl carbonates (such as dimethyl carbonate and diethyl carbonate), alkylene carbonates (such as ethylene carbonate or propylene carbonate), or phosgene. Optionally, a minor amount of higher functional, monomeric polyols, such as trimethylolpropane, glycerol or pentaerythritol, may be used.

In other examples, low molecular weight diols, triols, and higher alcohols may be included in the isocyanate-reactive material. In many embodiments, they can be monomeric and have hydroxyl values of 375 to 1810. Such materials can include aliphatic polyols, particularly alkylene polyols containing from 2 to 18 carbon atoms. Examples include ethylene glycol, 1,4-butanediol, 1,6-hexanediol, and cycloaliphatic polyols such as cyclohexane dimethanol. Examples of triols and higher alcohols include trimethylol propane and pentaerythritol. Also useful are polyols containing ether linkages such as diethylene glycol and triethylene glycol.

Thus, the aliphatic polyisocyanate can be or include a variety of aliphatic polyisocyanates, such as a linear aliphatic polyisocyanate, a cycloaliphatic polyisocyanate, an isocyanate-terminated reaction product of an aliphatic polyisocyanate and an isocyanate-reactive material, or a combination thereof. In some specific examples, the aliphatic polyisocyanate can include a blend of aliphatic polyisocyanates, such as one or more linear aliphatic polyisocyanates, one or more cycloaliphatic polyisocyanates, one or more reaction products of an aliphatic polyisocyanate and an isocyanate-reactive material, or a combination thereof. Generally, the coating composition does not include an aromatic polyisocyanate. In some examples, the coating composition includes less than 5 wt %, less than 1 wt %, less than 0.1 wt %, or less than 0.01 wt % of an aromatic polyisocyanate.

The aliphatic polyisocyanate described herein can be combined with a polyaspartate to prepare a low-VOC coating composition (e.g., a coating composition having less than or equal to 250 g VOCs/L of coating composition, for example). The aliphatic polyisocyanate can generally be combined with the polyaspartate composition at an equivalent ratio of from 0.9 to 1.8 (NCO/NH). In some additional examples, the aliphatic polyisocyanate can be combined with the polyaspartate at an equivalent ratio of from 0.9 to 1.2, from 1.1 to 1.3, from 1.2 to 1.5, from 1.4 to 1.6, from 1.5 to 1.7, or from 1.6 to 1.8 (NCO/NH).

In further detail, polyaspartates may be produced by the reaction of a polyamine with a Michael addition receptor, i.e., an olefin substituted on one or both of the olefinic carbons with an electron withdrawing group such as cyano, keto or ester (an electrophile) in a Michael addition reaction. Examples of suitable Michael addition receptors include, but are not limited to, acrylates, and diesters such as dimethyl maleate, diethyl maleate, dibutyl maleate, dimethyl fumarate, diethyl fumarate, and dibutyl fumarate.

Additionally, the polyaspartate can be prepared with a variety of polyamines, including low molecular weight diamines, high molecular weight diamines, or a combination thereof. Additionally, the polyamines can have a wide range of amine functionality, repeat unit type, distribution, etc. This wide range of molecular weight, amine functionality, repeating unit type, and distribution can provide versatility in the design of new compounds or mixtures.

Suitable low molecular weight diamines have molecular weights in various embodiments of from 60 to 400, in selected embodiments of from 60 to 300. Suitable low-molecular-weight diamines include, but are not limited to, ethylene diamine, 1,2- and 1,3-diaminopropane, 1,5-diaminopentane, 1,3-, 1,4- and 1,6-diaminohexane, 1,3-diamino-2,2-dimethyl propane, 2-methylpentamethylenediamine, isophorone diamine, 4,4′-diamino-dicyclohexyl methane, 4,4-diamino-3,3′-dimethyldicyclohexyl methane, 1,4-bis(2-amino-prop-2-yl)-cyclohexane, hydrazine, piperazine, bis(4-aminocyclohexyl)methane, and mixtures of such diamines Representative polyaspartates prepared from these low molecular weight diamines include DESMOPHEN NH-1220, DESMOPHEN NH-1420, and DESMOPHEN NH-1520, commercially available from COVESTRO.

In some additional embodiments of the invention, a single high molecular weight polyamine may be used. Also, mixtures of high molecular weight polyamines, such as mixtures of di- and trifunctional materials and/or different molecular weight or different chemical composition materials, may be used. The term “high molecular weight” is intended to include polyamines having a molecular weight of at least 400 in various embodiments. In selected embodiments, the polyamines have a molecular weight of from 400 to 6,000. Non-limiting examples can include polyethylene glycol bis(amine), polypropylene glycol bis(2-aminopropyl ether), the like, or a combination thereof.

In some specific examples, the polyamine can be an amine-terminated polyether. Commercially available examples of amine-terminated polyethers include, for example, the JEFFAMINE series of amine-terminated polyethers from Huntsman Corp., such as, JEFFAMINE D-230, JEFFAMINE D-400, JEFFAMINE D-2000, JEFFAMINE D-4000, JEFFAMINE T-3000 and JEFFAMINE T-5000.

In some examples, the polyaspartate composition may include one or more polyaspartates corresponding to formula (I):

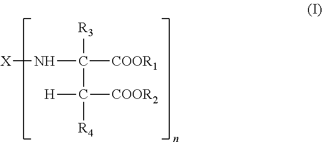

wherein:
n is an integer of at least 2;
X represents an aliphatic residue;
R₁ and R₂ independently of each other represent organic groups that are inert to isocyanate groups under reaction conditions; and
R₃ and R₄ independently of each other represent hydrogen or organic groups that are inert to isocyanate groups under reaction conditions.

In some additional examples, n has a value of from 2 to 6. In still additional examples, n has a value of from 2 to 4. In still additional examples, n has a value of 2.

In some examples, X represents an organic group that has a valency of n and is inert towards isocyanate groups at a temperature of 100° C. or less. In some additional examples, X represents a group obtained by removing amino groups from an aliphatic, araliphatic, or cycloaliphatic polyamine.

In some examples, R₁ and R₂ independently represent an alkyl group having from 1 to 9 carbon atoms. In some specific examples, R₁ and R₂ independently represent a methyl, ethyl, or butyl group. In still additional examples, R₁ and R₂, together form a cycloaliphatic or heterocyclic ring.

In some examples, the polyaspartate composition can include a blend of different polyaspartates. In other examples, the polyaspartate composition does not include a blend of different polyaspartates. Whether the polyaspartate composition includes a blend or not, the polyaspartate composition can generally have a relatively low solvent content. In some examples, the polyaspartate composition can include less than or equal to 20 wt % total solvents based on a total weight of the polyaspartate composition. In some additional examples, the polyaspartate composition can include less than or equal to 15 wt % total solvents, 12 wt % total solvents, 10 wt % total solvents, or less than or equal to 8 wt % total solvents based on a total weight of the polyaspartate composition. In some specific examples, the polyaspartate composition can be 100 wt % solids, or greater than 99 wt % solids, or greater than 95 wt % solids based on a total weight of the polyaspartate composition.

The coating composition formed by combining the aliphatic polyisocyanate with the polyaspartate also includes a pigment. Any suitable pigment can be included in the coating composition. For example, the pigment is not particularly limited based on color, particle size, refractive index, specific gravity, or the like.

The amount of pigment including in the coating composition can generally be at a pigment to binder ratio (P/B ratio) of from 0.05 to 1.3. As used herein, the P/B ratio is the weight ratio of the sum of the pigment solids (P) to the binder solids (B). In other examples, the pigment can be included at a P/B ratio of from 0.1 to 1.0. In some specific examples, the pigment can be included at a P/B ratio of from 0.1 to 0.4, from 0.3 to 0.5, from 0.4 to 0.7, from 0.5 to 1.0, or from 0.7 to 1.3.

In some examples, the addition of a pigment or other additive to the coating composition can also increase the moisture content in the coating composition, which can further increase the average viscosity build rate of the coating composition. Thus, increased water content in the coating composition can decrease the pot life of the coating composition. As such, the coating composition can also include a drying agent to extend the pot life of the coating composition. As used herein, “pot life” is based on a period of time during which the coating composition has a manageable viscosity. Specifically, a suitable pot life for the present coating composition can be defined as a period of time during which the coating composition has a viscosity of less than or equal to 120 Krebs units (KU) at 23° C. based on ISO 3219:2003. Thus, in some examples, the drying agent can extend the time period during which the coating composition has a viscosity of less than or equal to 120 KU at 23° C. based on ISO 3219:2003.

A variety of drying agents can be included in the pigmented coating composition. The drying agent can typically be a solid drying agent rather than a liquid drying agent (e.g., oxazolidines, para-toluene sulfonyl isocyanate, triethyl orthoformate, the like, or a combination thereof), although a liquid drying agent may be used alone, or in combination with a solid drying agent, in some examples. In some specific examples, the drying agent includes a solid drying agent, or a combination of a solid drying agent and a liquid drying agent. Non-limiting examples of solid drying agents can include a molecular sieve, calcium sulfate, calcium oxide, the like, or a combination thereof.

In some specific examples, the drying agent can be or include a molecular sieve. Where this is the case, a variety of molecular sieves can be employed in the coating composition. Non-limiting examples of molecular sieves can include aluminosilicates, porous glass, clay, active carbon, the like, or a combination thereof. In some specific examples, the molecular sieve can be or include an aluminosilicate, such as a zeolite.

The molecular sieve can typically have a water adsorption capacity of from 20 to 35 grams of water per 100 grams of molecular sieve (g water/100 g M.S.) at 25° C. and 40% relative humidity (R.H.). In some additional examples, the molecular sieve can have a water adsorption capacity of from 22 to 30 g water/100 g M.S. at 25° C. and 40% R.H. In some specific examples, the molecular sieve can have a water adsorption capacity of from 24 to 28 g water/100 g M.S. at 25° C. and 40% R.H. In some additional examples, the molecular sieve can have a water adsorption capacity of from 22 to 30 g water/100 g M.S. at 25° C. and 30% R.H. In still additional examples, the molecular sieve can have a water adsorption capacity of from 22 to 30 g water/100 g M.S. at 25° C. and 50% R.H. Water adsorption capacity can be determined by passing air saturated at a particular relative humidity over the molecular sieve until an equilibrium is reached at a pressure of less than 1″ Hg and at a temperature of 25° C. The amount of water adsorbed can be measured gravimetrically or by other suitable method.

The molecular sieve can have a variety of average particle sizes. As used herein, “particle size” refers to the largest diameter of a particle. Particle size can be determined by a variety of light scattering methods. In some examples, the molecular sieve can have an average particle size of from 4 μm to 12 μm. In some additional examples, the molecular sieve can have an average particle size of from 5 μm to 10 μm.

The molecular sieve can also have a variety of pore sizes. The pore size of a molecular sieve is typically defined by the particular ion used to prepare the molecular sieve, although other methods of determining the pore size can also be employed. In some examples, the molecular sieve can have an average pore size of from 1 Å to 12 Å. In some further examples, the molecular sieve can have an average pore size of from 2 Å to 10 Å. In some specific examples, the molecular sieve can have an average pore size of from 3 Å to 5 Å.

Additionally, in some examples the coating composition can further include a metal additive to further increase the pot life. A variety of metal additives of various oxidation states can be added to extend the pot life of the coating composition. In some examples, the metal additive can include a metal having a +2 oxidation state (e.g, zinc, nickel, etc.), a +3 oxidation sate (e.g., aluminum, indium, boron, cerium, etc.), a +4 oxidation state (e.g., tin, titanium, zirconium, etc.), or a +5 oxidation state (e.g., vanadium, niobium, etc.). In some specific examples, the metal additive can include a metal having a +4 oxidation state. Non-limiting examples of metals having a +4 oxidation state can include tin, titanium, manganese, zirconium, molybdenum, technetium, ruthenium, palladium, hafnium, tungsten, rhenium, osmium, iridium, platinum, cerium, or the like. In some further examples, the metal additive can be or include an organometallic compound or complex. In some examples, the metal additive can be or include an organometallic compound or complex including a metal having a +4 oxidation state, such as an organotin compound, an organotitanium compound, an organomanganese compound, an organozirconium compound, an organomolybdenum compound, an organotechnetium compound, an organoruthenium compound, an organopalladium compound, an organohafnium compound, an organotungsten compound, an organorhenium compound, an organoosmium compound, an organoiridium compound, an organoplatinum compound, an organocerium compound, the like, or a combination thereof. In other examples, the metal additive can be or include another type of chemical compound or complex including a metal having a +4 oxidation state.

In some specific examples, the metal additive can include a tin compound. A variety of tin compounds can be included in the coating composition. Non-limiting examples can be or include dibutyltin dilaurate, dimethyltin dichloride, dibutyltin dichloride, dibutyltin diacetate, stannous octoate, the like, or a combination thereof. In some specific examples, the tin compound can be or include dibutyltin dilaurate.

Where present, the tin compound can generally be included in the coating composition in an amount of from 0.01 wt % to 0.5 wt % based on a total amount of the coating composition. In some additional examples, the tin compound can be included in the coating composition in an amount of from 0.01 wt % to 0.1 wt %, from 0.05 wt % to 0.15 wt %, from 0.1 wt % to 0.2 wt %, from 0.15 wt % to 0.25 wt %, from 0.2 wt % to 0.3 wt %, from 0.25 wt % to 0.35 wt %, from 0.3 wt % to 0.4 wt %, from 0.35 wt % to 0.45 wt %, or from 0.4 wt % to 0.5 wt % based on a total weight of the coating composition.

In some specific examples, the metal additive can include a titanium compound. A variety of titanium compounds can be included in the coating composition. Non-limiting examples can include tetramethyl titanium, titanium (IV) ethoxide, titanium (IV) isopropoxide, titanium (IV) butoxide, the like, or a combination thereof. In some specific examples, the titanium compound can be or include titanium (IV) isopropoxide. In other examples, the titanium compound can be or include titanium (IV) butoxide.

Where present, the titanium compound can generally be included in the coating composition in an amount of from 0.001 wt % to 0.5 wt % based on a total amount of the coating composition. In some additional examples, the titanium compound can be included in the coating composition in an amount of from 0.001 wt % to 0.01 wt %, from 0.005 wt % to 0.05 wt %, from 0.01 to 0.1, from 0.1 wt % to 0.2 wt %, from 0.15 wt % to 0.25 wt %, from 0.2 wt % to 0.3 wt %, from 0.25 wt % to 0.35 wt %, from 0.3 wt % to 0.4 wt %, from 0.35 wt % to 0.45 wt %, or from 0.4 wt % to 0.5 wt % based on a total weight of the coating composition.

In some additional examples, the coating composition can include a manganese compound, a zirconium compound, a molybdenum compound, a technetium compound, a ruthenium compound, a palladium compound, a hafnium compound, a tungsten compound, a rhenium compound, an osmium compound, an iridium compound, a platinum compound, or a combination thereof. Where this is the case, the individual metal additive can generally be included in the coating composition in an amount of from 0.001 wt % to 0.5 wt % based on a total amount of the coating composition. In some additional examples, the metal additive can be individually included in the coating composition in an amount of from 0.001 wt % to 0.01 wt %, from 0.005 wt % to 0.05 wt %, from 0.01 wt % to 0.1 wt %, from 0.05 wt % to 0.15 wt %, from 0.1 wt % to 0.2 wt %, from 0.15 wt % to 0.25 wt %, from 0.2 wt % to 0.3 wt %, from 0.25 wt % to 0.35 wt %, from 0.3 wt % to 0.4 wt %, from 0.35 wt % to 0.45 wt %, or from 0.4 wt % to 0.5 wt % based on a total weight of the coating composition.

It is further noted that the coating composition can optionally include one or more additional additives, such as a thixotropic agent, a dispersing agent, a flow aid, a surfactant, a thickener, a solvent, a leveling agent, the like, or a combination thereof.

The coating composition can generally have a total solvent content (i.e., all solvents, including exempt solvents) of less than or equal to 250 grams VOCs per liter of coating composition (g/L). In still additional examples, the coating composition can have a total solvent content of less than or equal to 200 g/L, less than or equal to 180 g/L, less than or equal to 140 g/L, less than or equal to 120 g/L, or less than or equal to 100 g/L. In some further examples, the coating composition can have a total solids content of greater than or equal to 80 wt %, greater than or equal to 85 wt %, greater than or equal to 90 wt %, greater than or equal to 91 wt %, greater than or equal to 92 wt %, greater than or equal to 93 wt %, greater than or equal to 94 wt %, greater than or equal to 95 wt %, greater than or equal to 96 wt %, greater than or equal to 97 wt %, greater than or equal to 98 wt %, or greater than or equal to 99 wt % based on a total weight of the coating composition. In still additional examples, the coating composition can have a solids content of 100 wt %. In some specific examples, the coating composition can have a solids content of from 85 wt % to 95 wt %, from 91 wt % to 99 wt %, from 92 wt % to 98 wt %, or from 93 wt % to 97 wt % based on a total weight of the coating composition.

A variety of solvents can be used to dilute the coating composition and reduce the viscosity thereof. These solvents can include exempt solvents (e.g., t-butyl acetate), non-exempt solvents, or a combination thereof. Non-limiting examples of solvents that can be employed in the polyisocyanate composition can include ethyl acetate, butyl acetate, 1-methoxy propyl-acetate-2, acetone, methyl ethyl ketone, methyl isobutyl ketone, cyclohexanone, toluene, xylene, solvent naphtha, the like, or a combination thereof. In some examples, where a solvent is employed, the solvent can be added to the aliphatic polyisocyanate prior to combining the aliphatic polyisocyanate with the polyaspartate composition. In some other examples, the solvent can be added to the polyaspartate composition prior to combining the aliphatic polyisocyanate with the polyaspartate composition. In still other examples, the solvent can be added to both the aliphatic polyisocyanate and the polyaspartate composition prior to combining aliphatic polyisocyanate with the polyaspartate composition.

Depending on the aliphatic polyisocyanate and the polyaspartate composition employed, the coating composition can have a variety of initial viscosities. Generally, the coating composition can have an initial viscosity of from 55 Krebs units (KU) to 90 KU at 23° C. based on ISO 3219:2003. As used herein, “initial viscosity” or Vᵢ refers to the viscosity determined according to ISO 3219:2003, generally within the first 5 minutes after initial mixing of the aliphatic polyisocyanate and the polyaspartate. In some specific examples, the coating composition can have an initial viscosity of from 55 KU to 65 KU, from 60 KU to 70 KU, from 65 KU to 75 KU, from 70 KU to 80 KU, from 75 KU to 85 KU, or from 80 KU to 90 KU at 23° C. based on ISO 3219:2003.

Additionally, the coating composition can generally maintain a relatively low viscosity for a sufficient amount of time to apply the coating composition to a surface. As described above, this can generally be referred to as the “pot life” of the coating composition. More specifically, a suitable pot life can generally refer to a period of time over which the coating composition has a viscosity of less than 120 KU at 23° C. based on ISO 3219:2003. With this in mind, the coating composition can generally have a viscosity of less than or equal to 120 KU at 23° C. based on ISO 3219:2003 for a period of at least 1.5 or 2 hours after initial mixing. In other examples, the coating composition can have a viscosity of less than 110 KU at 23° C. based on ISO 3219:2003 for a period of at least 1.5 or 2 hours after initial mixing. In still additional examples, the coating composition can have a viscosity of less than 105 KU or less than 100 KU at 23° C. based on ISO 3219:2003 for a period of at least 1.5 or 2 hours after initial mixing. In some specific examples, the coating composition can have a viscosity at 23° C. based on ISO 3219:2003 of from 65 KU to 115 KU at 1.5 or 2 hours after initial mixing. In some additional specific examples, the coating composition can have a viscosity at 23° C. based on ISO 3219:2003 of from 60 KU to 80 KU, from 65 KU to 85 KU, from 70 KU to 90 KU, from 75 KU to 95 KU, from 80 KU to 100 KU, from 90 KU to 110 KU, or from 100 KU to 120 KU at 1.5 or 2 hours after initial mixing.

In some further examples, the coating composition can be defined based on the average viscosity build rate of the coating composition. The average viscosity build rate can be determined by measuring the viscosity of the coating composition at 15-minute intervals from an initial viscosity or V, of the coating composition up to a viscosity of 120 KU (or the highest viscosity reading within the V, to 120 KU range) or for a period of 2 hours, whichever occurs sooner. Each of the viscosity build rates for the individual 15-minute intervals can then be averaged to determine the average viscosity build rate of the coating composition in KU/min With this in mind, the coating composition can generally have an average viscosity build rate of less than 0.5 KU/min based on ISO 3219:2003. In still additional examples, the coating composition can have an average viscosity build rate of less than 0.4 KU/min based on ISO 3219:2003.

In some additional examples, the coating composition can dry relatively quickly to form a coating, which is referred to herein as a hard-dry time. For example, in some cases, the coating composition can have a hard-dry time of less than 8 hours, or from 1 hour to 7 hours based on ASTM D5895-03. In some additional examples, the coating composition can have a hard-dry time of from 1 hour to 3 hours, from 2 hours to 4 hours, from 3 hours to 5 hours, or from 4 hours to 6 hours based on ASTM D5895-03. Additionally, the coating composition can typically provide a coating having a pencil hardness of at least 3B, at least 1H, or at least 2H after hard dry.

The coating composition can be coated on a variety of substrates. Non-limiting examples of substrates can include metals, plastics, wood, cement, concrete, glass, the like, or a combination thereof.

The coating composition can be applied by spraying, knife coating, curtain coating, vacuum coating, rolling, pouring, dipping, spin coating, squeegeeing, brushing, squirting, printing, the like, or a combination thereof. Printing techniques can include screen, gravure, flexographic, or offset printing and also various transfer methods.

The coating composition can be applied to substrate at a variety of coating thicknesses. For example, in some cases, the coating composition can be applied to a surface portion of a substrate at a coating thickness of from 1 thousandth of an inch (mil) to 16 mils. In other examples, the coating composition can be applied to a surface portion of a substrate at a coating thickness of from 1 mil to 5 mils, from 3 mils to 9 mils, from 6 mils to 12 mils, or from 10 mils to 16 mils.

### EXAMPLES

Materials used in the examples:

| | |
|---|---|
| Polyaspartate A | a 100% solids content aspartic ester functional amine, |
| | having an amine number of approx. 200 mg KOH/g, |
| | viscosity @ 25° C. of 1100-1500 mPa · s; |
| Polyaspartate B | a 100% solids content aspartic ester functional amine, |
| | having an amine number of approx. 190 mg KOH/g, |
| | viscosity @ 25° C. of 1000-1800 mPa · s; |
| Polyisocyanate A | aliphatic polyisocyanate based on allophanated |
| | HDI trimer having an NCO % of 20 wt % based on |
| | ISO 11909: 2007 and a number average functionality |
| | of 2.5 based on gel permeation chromatography. |
| Polyisocyanate B | aliphatic polyisocyanate based on HDI trimer |
| | having an NCO % of 21.8% based on ISO |
| | 11909: 2007 and a number average functionality |
| | of 3.5 based on gel permeation chromatography. |
| Polyisocyanate C | aliphatic polyisocyanate based on a reaction |
| | product of HDI and a polyether polyol having an |
| | NCO % of 6% based on ISO 11909: 2007 and a |
| | number average functionality of 4 based on gel |
| | permeation chromatography. |
| Additive A | dibutyltin dilaurate commercially available from |
| | EVONIK |
| Additive B | titanium (IV) isopropoxide commercially available |
| | from SIGMA-ALDRICH |
| Additive C | zeolite molecular sieve powder having a pore size |
| | of 4 Å commercially available from W. R. |
| | Grace & Co. |
| Additive D | n-butyl acetate commercially available from SIGMA- |
| | ALDRICH |
| Additive E | a solvent-free wetting and dispersing additive |
| | commercially available from BYK |
| Additive F | micronized amide-modified castor wax rheology |
| | modifier commercially available from PALMER |
| | HOLLAND |
| Additive G | titanium dioxide pigment |

### Example 1—Low-VOC Pigmented System with and without Drying Agent

An example pigmented coating composition, Coating Composition 1A, was prepared having a total solvent content of 100 g/L. Specifically, a polyisocyanate composition including 70:30 Polyisocyanate A to Polyisocyanate C was combined with a polyaspartate composition including 70:30 Polyaspartate A to Polyaspartate B at an equivalent ratio of 1.1 (NCO/NH) and diluted with Additive D to form the Coating Composition 1A. Coating Composition 1A also included 2 wt % Additive A, 1 wt % Additive E, and 2 wt % Additive F based on a total weight of Coating Composition 1A. Further, Additive G was included at a 0.4 pigment to binder ratio (P/B ratio). A suitable pot life for the coating composition was set as a viscosity at 2 hours after initial mixing of less than or equal to 120 KU at 23° C. based on ISO 3219:2003. However, Coating Composition 1A had a viscosity at 2 hours after initial mixing of much greater than 140 KU. Interestingly, it was observed that Coating Composition 1A had an initial water content approaching 3000 ppm based on a Karl Fischer water titration performed soon after initial mixing.

Another coating composition, Coating Composition 1B, was prepared that was identical to Coating Composition 1A except that it also included 2 wt % Additive C to help sequester water in the composition. As can be seen in Table 1, the addition of Additive C increased the pot life (decreased the viscosity at 2 hours after initial mixing) of the coating composition by a considerable amount.

TABLE I
Effect of Drying Agent on Pot Life

| | | Starting | Viscosity @ | |
|---|---|---|---|---|
| | | Viscosity | 2 hours | Rate |
| Sample | Index | (KU) | (KU) | (KU/min) |
| 1A | 1.1 | 75.6 | >140 | 1.910 |
| (Comparative) | | | | |
| 1B | 1.1 | 74.6 | 104.1 | 0.239 |
| (Inventive) | | | | |

Additional low-VOC coating compositions were prepared to further explore the benefit of adding a drying agent to the formulation. Specifically, Coating Compositions 1C and 1D were prepared by combining Polyisocyanate A and Polyaspartate A at an equivalent ratio of 1.6 and diluting to a total solvent content of 100 g/L using Additive D. Additive C was added to each coating composition at 1 wt % and 2 wt % based on a total weight of the respective coating compositions. Each coating composition also included 3 wt % Additive E based on a total weight of the respective coating compositions and Additive G at a 0.4 P/B ratio.

As can be seen in Table II, both Coating Composition 1C and 1D had a longer pot life than either of Coating Compositions 1A or 1B. Considering that Coating Compositions 1B and 1D both included 2 wt % Additive C, it was believed that the increased NCO:NH index also helped increase the pot life of Coating Composition 1D relative to Coating Composition 1B (further explored in Example 3). Hard dry times were also measured in this study. An acceptable hard dry time was considered to be from 40 minutes to 480 minutes based on ASTM D5895-03.

TABLE II
Effect of Drying Agent on Pot Life and Hard Dry Time

| | | Starting | Viscosity @ | | Hard- |
|---|---|---|---|---|---|
| | Additive C | Viscosity | 2 hours | Rate | Dry Time |
| Sample | (wt %) | (KU) | (KU) | (KU/min) | (min) |
| 1C | 1 | 62.1 | 90.4 | 0.236 | 90 |
| 1D | 2 | 61.9 | 83.8 | 0.183 | 120 |

### Example 2—Effect of Metal Additives on Pot Life and Hard Dry Time

All coating compositions were prepared at a total solvent content of 100 g/L by combining Polyisocyanate A and Polyaspartate A at an equivalent ratio of 1.6 (NCO/NH) and diluting with Additive D. Each of the coating compositions also included 2 wt % Additive C and 3 wt % Additive E based on a total weight of the respective coating compositions. Additionally, Additive G was included in each coating composition at a 0.4 P/B ratio. Each of the coating compositions included varying amounts of metal additives as reported in Table IV. Pot life and hard dry times were measured for each of the coating compositions to determine the impact of metal additive amounts on those properties. Acceptable pot life and hard dry time values are those described above in Example 1.

TABLE III
Effect of Metal Additive on Pot Life and Hard Dry Time

| | | | Starting | Viscosity | | Hard- |
|---|---|---|---|---|---|---|
| | Additive A | Additive B | Viscosity | @ 2 hours | Rate | Dry Time |
| Sample | (wt %) | (wt %) | (KU) | (KU) | (KU/min) | (min) |
| 1E | 0 | 0 | 61.9 | 83.8 | 0.183 | 120 |
| 2A | 0 | 0.05 | 62.1 | 78.0 | 0.114 | 85 |
| 2B | 0.05 | 0 | 61.9 | 71.4 | 0.066 | 95 |
| 2C | 0.025 | 0.025 | 62.4 | 71.8 | 0.078 | 135 |
| 2D | 0 | 0.025 | 61.9 | 89.6 | 0.231 | 150 |
| 2E | 0.025 | 0 | 62.1 | 69.9 | 0.065 | 150 |
| 2F | 0.012 | 0.012 | 62.4 | 73.8 | 0.096 | 150 |
| 2G | 0.036 | 0.004 | 62.4 | 69.6 | 0.061 | 105 |
| 2H | 0.027 | 0.003 | 62.8 | 70.5 | 0.064 | 150 |
| 2I | 0.018 | 0.002 | 62.6 | 71.2 | 0.072 | 135 |
| 2J | 0.009 | 0.001 | 62.8 | 77.2 | 0.120 | 135 |

Table III makes it clear that the addition of some combinations of metal additives can extend the pot life beyond what the addition of a drying agent can achieve alone, without adversely affecting the hard-dry time of the coating.

### Example 3—Effect of Index on Pot Life and Hard Dry Time

All coating compositions were prepared at a total solvent content of 100 g/L by combining Polyisocyanate A and Polyaspartate A at various equivalent ratios ranging from 1.05 to 3.0 and diluting with Additive D. Each of the coating compositions also included 0.012 wt % Additive A, 0.012 wt % Additive B, 2 wt % Additive C, and 3 wt % Additive E based on a total weight of the coating compositions. Additive G was included in each of the coating compositions at a 0.4 P/B ratio. The effects of index on the coating compositions are presented in Table IV.

TABLE IV
Effect of Index on Pot Life and Hard Dry Time

| | | Starting | Viscosity @ | | Hard- |
|---|---|---|---|---|---|
| | | Viscosity | 2 hours | Rate | Dry Time |
| Sample | Index | (KU) | (KU) | (KU/min) | (min) |
| 3A | 1.05 | 63.3 | 78.6 | 0.128 | 50 |
| (Inventive) | | | | | |
| 3B | 1.2 | 62.8 | 76.6 | 0.115 | 50 |
| (Inventive) | | | | | |
| 3C | 1.4 | 62.4 | 75.4 | 0.108 | 65 |
| (Inventive) | | | | | |
| 3D | 1.6 | 62.4 | 73.8 | 0.096 | 150 |
| (Inventive) | | | | | |
| 3E | 2.0 | 62.6 | 72.6 | 0.083 | >720 |
| (Comparative) | | | | | |
| 3F | 3.0 | 62.1 | 69.2 | 0.059 | >720 |
| (Comparative) | | | | | |

As can be seen in Table IV, the index of the polyisocyanate to the polyaspartate can play an important role in the hard dry time. For example, while each of Coating Compositions 3A-3F had an acceptable pot life, Coating Compositions 3E and 3F had a hard dry time that was much longer than desired.

### Example 4—Coating Composition with Thixotropic Agent

The coating composition was prepared at a total solvent content of 100 g/L by combining Polyisocyanate A and Polyaspartate A at an equivalent ratio of 1.6 and diluting with Additive D. The coating composition also included 0.027 wt % Additive A, 0.003 wt % Additive B, 2 wt % Additive C, and 3 wt % Additive E based on a total weight of the coating composition. The coating composition also included Additive G at a 0.4 P/B ratio. As some coating compositions also benefit from the addition of the thixotropic agent for vertical coating applications, 1.5 wt % Additive F was also included in the formulation to determine whether it would adversely affect the pot life of the coating composition. As can be seen in Table V, Coating Composition 4A had an acceptable pot life when Additive F was included.

TABLE V
Coating Composition with Thixotropic Agent

| | Starting | Viscosity @ | |
|---|---|---|---|
| | Viscosity | 2 hours | Rate |
| Sample | (KU) | (KU) | (KU/min) |
| 4A | 71.4 | 105 | 0.280 |

### Example 5—Coating Compositions with Different Polyisocyanates

All coating compositions were prepared at a total solvent content of 100 g/L by diluting with Additive D. Coating Composition 2H was prepared as described above. Coating Composition 5A was prepared identically to Composition 2H except Coating Composition 5A was prepared with Polyisocyanate B instead of Polyisocyanate A.

| | Starting | Viscosity @ | | Hard- |
|---|---|---|---|---|
| | Viscosity | 2 hours | Rate | Dry Time |
| Sample | (KU) | (KU) | (KU/min) | (min) |
| 2H | 62.8 | 70.5 | 0.064 | 150 |
| 5A | 73.0 | 91.4 | 0.154 | 60 |

While Polyisocyanate B provided a much shorter pot life and relatively fast hard dry time as compared to Polyisocyanate A, Polyisocyanate B remained a reasonable polyisocyanate for use in the coating compositions described herein.

It should be understood that the above-described examples are only illustrative of some embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations including, may be made without departing from the principles and concepts set forth herein.

What is claimed is:

1. A coating composition, comprising:
an aliphatic polyisocyanate and a polyaspartate combined at an equivalent ratio of from 0.9 to 1.8, the aliphatic polyisocyanate having an NCO % of from 6 wt % to 25 wt % based on ISO 11909:2007;
a pigment at a pigment to binder ratio of from 0.05 to 1.3; and
a drying agent in an amount of from 0.5 wt % to 5 wt % based on a total weight of the coating composition,
wherein the coating composition has a total solvent content of less than or equal to 250 g/L.

2. The coating composition of claim 1, wherein the aliphatic polyisocyanate comprises an HDI polyisocyanate, a PDI polyisocyanate, or a combination thereof.

3. The coating composition of claim 1, wherein the aliphatic polyisocyanate comprises a trimer, an allophanate, or a combination thereof.

4. The coating composition of claim 1, wherein the aliphatic polyisocyanate has a number average isocyanate functionality of from 2.3 to 3.7 based on gel permeation chromatography.

5. The coating composition of claim 1, wherein the aliphatic polyisocyanate has a weight average molecular weight of from 400 g/mol to 2500 g/mol based on gel permeation chromatography.

6. The coating composition of claim 1, wherein the pigment is present at a pigment to binder ratio of from 0.1 to 1.0.

7. The coating composition of claim 1, wherein the drying agent comprises a molecular sieve.

8. The coating composition of claim 7, wherein the molecular sieve has a water absorption capacity of from 20 to 35 g water/g molecular sieve at 25° C. and 40% R.H.

9. The coating composition of claim 7, wherein the molecular sieve has a pore size of from 1 Å to 12 Å.

10. The coating composition of claim 1, further comprising a metal additive in an amount of from 0.01 wt % to 0.1 wt % based on a total weight of the coating composition.

11. The coating composition of claim 10, wherein the metal additive comprises a tin compound.

12. The coating composition of claim 11, wherein the tin compound is dibutyltin dilaurate.

13. The coating composition of claim 10, wherein the metal additive comprises a metal having a +4 oxidation state.

14. The coating composition of claim 1, wherein the coating composition has an initial viscosity of from 55 KU to 90 KU at 23° C. based on ISO 3219:2003,

15. The coating composition of claim 1, wherein the coating composition has a viscosity of less than or equal to 120 KU at 23° C. based on ISO 3219:2003 for at least 1.5 hours after mixing.

16. The coating composition of claim 1, wherein the coating composition has a weight solids content of from 91 wt % to 99 wt % based on a total weight of the coating composition.

17. A coated substrate, comprising:
a substrate having the coating composition of claim 1 applied to a surface portion thereof, wherein the coating composition is applied at a coating thickness of from 1 mil to 16 mil.

18. The coated substrate of claim 17, wherein the substrate comprises metal, plastic, wood, cement, concrete, glass, or a combination thereof.

19. A method of manufacturing a coating composition, comprising:
combining an aliphatic polyisocyanate and a polyaspartate at an equivalent ratio of from 0.9 to 1.8, wherein the aliphatic polyisocyanate has an NCO % of from 6 wt % to 25 wt % based on ISO 11909:2007, wherein the coating composition has a total solvent content of less than or equal to 250 g/L, and wherein the coating composition further comprises:
a pigment at a pigment to binder ratio of from 0.05 to 1.3; and
a drying agent in an amount of from 0.5 wt % to 5 wt % based on a total weight of the coating composition.

20. The method of claim 19, further comprising diluting the coating composition with a solvent.
